(19) United States
(12) Patent Application Publication
(10) Pub. No.: US 2007/0283625 A1
(43) Pub. Date: Dec. 13, 2007

(54) Hurricane resistant screen system

(76) Inventors: John Morrissey, Bonita Springs, FL (US); Alan Greene, Wayzata, MN (US)

Correspondence Address: Mark A. Litman & Associates, P.A.;York Business Center, Suite 205, 3209 West 76th St., Edina, MN, 55435, US

(21) Appl. No.: 11/799,741

(22) Filed: May 2, 2007

Related U.S. Application Data
(60) Provisional application No. 60/797,040, filed on May 2, 2006.

(51) Int. Cl. E06B 7/08

(52) U.S. Cl. 49/87.1; 160/371; 49/92.1

(57) ABSTRACT

A screen system for providing cover may has a structural frame; at least one screen panel; a fastenable connection system between one side of the structural frame and an opposed side of the at least one screen panel, and a grasping element extending out of or into a side of the screen panel opposite the opposed side of the at least one screen panel. Force can be applied to the grasping element to disengage the fastenable connection system while retaining structure in the fastenable connection system so that a disengaged screen panel can be reattached to the structural frame.

### RELATED APPLICATION DATA

This Application claims priority from U.S. Provisional Patent Application No. 60/797,040 filed May 2, 2006.

### BACKGROUND OF THE INVENTION

1. Field of the Invention

The present invention concerns a system and assembly which enhances the hurricane survivability of outdoor screening systems. Such systems are used extensively in southern climates to prevent insects and other pests from entering areas around swimming pools, porches, or outdoor recreations areas. In recent years these screening systems have been particularly prone to damage from high winds of hurricanes, tornadoes and tropical storms. The current screening systems in use tend to be rigid in structure, labor intensive to install and cannot be readily removed in the event of storms. The screening systems in use currently multiply the effect of winds on the basic structure by acting as levers transmitting the force of winds to the underlying structure in similar fashion to the way sails transfer force to the mast of a sailboat. The system and assembly of the invention permits the screens to be easily installed on the structure and permits the screens to be easily removed at the approach of a storm, and reattached easily when the storm danger has passed.

2. Background of the Invention

Long term climate studies over the past 100 years indicate that hurricane frequency and intensities are cyclic. After a lull of ca. twenty years we now appear to be in the early half of a cycle during which we can anticipate frequent intense hurricanes for the next ten years or more. The hurricanes of the past few years have been particularly devastating to the gulf and coastal states of the US. Current estimates of the damages in Florida alone amount to several billions of dollars each year for the past three years.

One structure which has been particularly susceptible to damage have been screened enclosures commonly used as protection against bugs, flies, mosquitoes, ‘no-see-ums’, and other pests. Such screen systems are essential protections in many areas and pools and patios would be unusable without them. These screen structures can be elaborate and cover areas from a few hundred square feet, for a lanai or apartment building, to thousands of square feet. The cost of these structures can range from a few thousand dollars to well over $100,000.

These structures have proven to be particularly susceptible to hurricanes, and have been a major component of the billions of dollars of losses experienced these past few years. Their susceptibility to damage has been so great that many insurance companies have either refused to cover these structures or have made rates so high as to preclude their application.

Examination of hurricane damaged structures indicate that the basic metal framework has enough strength to resist damage during most hurricanes, but that the screening acts as a sail much as a sail would act on the mast of a sailing vessel during a storm, multiplying and transferring the wind loads to the structure so that the loads exceed the endurance of the basic structure causing deformation and failure. The solution to save the screened structures from damage is similar to the solution to avoid failure of the mast of the sailing boat, that is, to lower the screens just as one would lower the sails during a storm. Unfortunately the current design and fabrication of the pool and lanai screens makes it impossible to remove the screen readily, or if removed to replace them easily and inexpensively.

This invention permits easy, rapid, inexpensive, non-destructive removal of such screens, and when the danger and/or actual hurricane has passed, permits the reinstallation of the screens easily and inexpensively as well. In addition, the basic design is such that the original fabrication/installation of the screens is expected to be less expensive than any current design. Further, there is no loss of aesthetic appearance or of the effectiveness of the screens in their primary purpose of keeping the interior spaces free of pests. The use of this invention promises to have an important impact on homes and condos in the path of hurricanes, producing lower initial costs, reducing hurricane damage substantially if not entirely, and very substantial reductions in insurance premiums as hurricane losses are reduced and insurance companies return to a market with predictable low risks.

In cities, and even some more rural settings, personal privacy is often difficult to maintain. As land use restrictions increase and the size of the average house lot decreases solitude becomes a premium for the homeowner or apartment tenant. Specifically, a homeowner may want to enjoy his or her backyard patio or pool only to find that the neighbors have a clear view of the homeowner's activities. These intrusions are compounded if the homeowner or tenant lives along the water, a golf course or other area with heavy traffic. For example, many luxury homes are constructed along golf courses. For the homeowner, one of the enticements for purchasing the home was its location and view. However, golfers while walking along the fairway or chasing after a stray golf ball can often literally look into the home's kitchen, patio, or pool area. Additionally, these encroachments by passersby can occur at lake homes, at homes along waterways or rivers and even at restaurants with outdoor eating areas. However, the need for privacy is probably most felt those individuals who live in close proximity to one another such as residents of newer housing developments, townhouse or condominium owners and apartment tenants.

Additionally, in most locations where pools are used, the facility must be protected against unwanted intrusion, whether by people, local fauna or wind-blown waste. Intrusion by raccoons, squirrels, turtles, birds, insects and even alligators can render the pools temporarily unusable and enable damage to the pool facility or furniture from the animals. It is therefore common, especially in more southern climates, to have the pools or decks or even tennis courts fully enclosed by a screen system.

A homeowner or renter who desires to increase the privacy around their pool, patio or home has few options. Installation of solid fencing or a pool and patio enclosure is not only expensive but can result in the loss of view, loss of the pleasant breeze or loss of the feeling of being outdoors. Homeowners or renters who enjoy the benefits of an outdoor pool area are unlikely to be content with the cumbersome, unattractive, fixed, and generally ill-suited alternatives currently available to provide some privacy to an open-air area. More importantly, as many of these screened-in facilities are in the southeast United States and along the Gulf Coast, they are subject to the forces of violent storms and especially hurricanes and tornadoes.

The screen systems are subject to extreme damage from these storms, and the cost and likelihood of damage in such screen systems has caused the insurance rates on such structures to greatly increase or for companies to refuse to insure such structures. Even state cooperative funds for such insurance of enclosure structures are hard-pressed to cover the cost of the damage or provide insurance. However, the pool has become a significant part of the life style in many regions and the screen structures are an important part enabling use and enjoyment of the structure and facility.

Historically, fabric structures, enclosures, screens and fences have been used for a variety of applications. Large fabric domes cover outdoor arenas, shopping malls, swimming pools, tennis courts and other locations having a need for a customized shelter. However, due to their size and complexity and ease of wind damage, fabric domes are not well-suited for an individual homeowner, especially if the area sought to be enclosed is small or has some type of overhang.

A current practice, most often utilized for above ground swimming pools or hot tubs, is to build a semi-permanent enclosure made up of vertical sidewalls including a fence-like portion and a ventilating window portion. For instance, U.S. Pat. No. 4,901,484 (Santosuosso) teaches a swimming pool enclosure which is constructed to overlie and completely enclose a swimming pool and surrounding a planar structural deck surface area. The enclosure structure is designed to be a permanent structure and therefore utilizes support channels bored into the concrete deck. Additionally, since the enclosure is intended to extend the usable season for an above-ground swimming pool, a complex roof support framework and cover is required.

U.S. Pat. No. 5,148,646 (Lutostanski) teaches a convertible enclosure adapted to cover an outside hot tub installation. Due to its intended function, enclosing a hot tub or spa during inclement weather, the cover requires an overhead support skeleton capable of supporting a durable, weatherproof vinyl cover, which is also subject to wind damage.

An alternative approach, in warmer climates, is to install screen material at the base of the pool enclosure. This screen material may be a polymeric, metallic or fiberglass screen. Some may even include a polymer window or additional layer, such as an opaque or frosted vinyl. However basic screen materials are readily subject to wind damage due to the force of winds in violent southern storms.

Individual or module privacy screens are well-known. However, these screens are intended for use indoors, specifically in an office environment. See for instance U.S. Pat. No. 5,287,909 (King et al.) which relates to freestanding privacy screens shaped to be positioned in a side-by-side relationship. These modular screens are designed to form office cubicles and are characterized by their substantial, solid construction.

U.S. Pat. No. 5,046,546 (Benedyk) describes a screen enclosure apparatus for use in screened windows, porches, doors and other screened-in building structures, capable of controllably breaking away upon excessive impact of resultant wind pressures on the frame of the apparatus. A frame structure having a channel running along the frame's length, serves to releasably or frangibly receive spline material which displaces or fractures at a predetermined resultant pressure. The spline serves to releasably secure a screen sheet, within the channel of the frame itself, so as to preclude damage which would otherwise occur not only to the screen sheet, but also to the supporting frame structures, when such high wind pressures are exerted thereon—to reduce the structural rigidity requirements for such frames. Venting members are also utilized to minimize contact between the spline and potentially corrosive elements which may be prevalent in the channel of the frame, and are further used to reduce the likelihood of certain kinds of corrosion from actually occurring within the channel, as well as adhesion of the spline to areas of corrosion. There is no evidence that such a system will perform as claimed and no scientific or engineering principle to expect that any of these claims will be realized.

U.S. Pat. No. 5,680,893 (Neer) discloses a privacy screen assembly, comprising: a decorative screen, said decorative screen including upper and lower edges, first and second sides, and left and right edges, wherein said decorative screen comprises a base screen and a decorative pigmented coating; frame means for supporting said decorative screen in a vertical planar orientation; and attachment means by which said decorative screen may be attached to said frame means, wherein said decorative pigment coating is provided on at least said first side and comprises at least two different colors, said different colors cooperating to define a reflected pattern in said decorative screen when viewed from said first side, such that the light reflective and absorptive properties of the decorative pattern viewed from said first side decrease the ability of a viewer to view activities or persons on the opposite side of the screen. Among the structural features described for support of the hanging screen of Neer are attachment means by which the screen is suspended being hooks, clamps, or any hanging hardware which would permit the decorative screen to be uniaxially movable (i.e. slide) within the overhead frame. The decorative curtain can be suspended in a manner similar to a curtain, panel, or on a roller system. In a still further refinement, the hooks, clamps, or hanging hardware have a release mechanism whereby the decorative screen will disengage from the supporting frame structure during high winds or inclement weather, thereby preventing damage to the screen assembly system. The hanging hardware release mechanism may utilize magnets, snaps, VELCRO™ or any means which would allow the decorative screen to detach from the hanging hardware and frame support during a high wind. Additionally, the lower edge of the screen may have incorporated therein releasable fasteners such as VELCRO™, magnets, or snaps which would permit the screen to disengage from the frame means during inclement weather. Preferably the release fasteners have a release pressure of 2 pounds or less, however this pressure may vary given the dimensions of the privacy screen assembly and the general weather conditions of the local in which the privacy screen assembly is utilized. The Neer patent is for a decorative privacy screen similar to curtains or drapes inside a home and does not envision these curtains or drapes providing a complete barrier to insects such as is required for the pest free screens covered in this application. Such screens and/or curtains do not place as high of stress on the structure supporting these curtains and/or drapes and do not necessarily resemble the screens used to provide protection against pests.

All references cited herein are incorporated by reference in their entirety.

### SUMMARY OF THE INVENTION

A screen support structure has panels or sections of screen material supported on a frame, and the frames have external attaching or grasping elements on a surface. In advance of a storm or other event that might damage the screen material, the attaching or grasping elements are engaged by a user and the panels removed from the frame by force provided by the user. The frames can be readily reattached by the application of force or snap engagement to the frame when the threat of a storm or damaging conditions has passed. A thirty panel cover system can be disassembled in as little as 5 minutes with the system.

A pool, patio or lanai screen system consists of any structural material, including materials from a non-limiting list of wood, polymer, reinforced polymer, composites, steel, aluminum, or other sturdy structural material skeleton or frame which provides the basic structural strength for the entire system. While the pattern of the structure depends upon the overall height, length, and width of the total structure, the pattern usually results in open squares, rectangles, and/or triangular shapes, varying from a few feet on a side to ten or fifteen feet and possibly having reinforcements such as cables to add stiffness and structural strength to the structure. The openings in the basic framework are then completely covered with fine mesh screening to prevent access to the area by pests. The fine mesh screening necessary to keep out pests however, acts to amplify and transmit wind loads to the basic structure which may result in the damage or destruction of the total structure during high velocity wind storms such as hurricanes.

Current usage and practice is to attach the screen materials and to the frames by means of channels extruded in the basic structural frame in which the perimeter edges of the screen are first laid and secured by long splines of rubber or composite materials which are forced into the channels over the screen material. The attachment system once in place is difficult, time consuming, and expensive to remove and generally causes damage to the spline and/or screening material in the removal process. Users consequently have no practical way of avoiding whatever damage storms may bring. This invention secures the screen to the structural elements which readily permits the rapid complete or partial removal of the screens when high velocity winds threaten and permits easy, quick, and inexpensive reattachment of the screens to the structure when weather returns to normal.

### BRIEF DESCRIPTION OF THE FIGURES

FIG. 1 shows a perspective view of a screen enclosure for a pool or deck.

FIG. 2 shows a perspective of a partially disassembled screen enclosure system for a pool or deck.

FIG. 3 shows a front view of a panel.

FIGS. 3A, 3B and 3C show alternative grasping assemblies from frames.

FIG. 3D shows a back view of a base support for securing removable screen supports.

### DETAILED DESCRIPTION OF THE INVENTION

A screen system for pools, porches, patios, decks, tennis courts, play areas and the like is provided that can be rapidly disassembled or put into a protected orientation rapidly. The screen system can also be reassembled easily without the need for significant mechanical skills. The system provides as good protection as existing systems, with the added advantage of being able to be disassembled and reassembled quickly and easily to avoid damage from storms.

The screen system for providing cover may comprise: a structural frame having height; at least one screen panel; a fastenable connection system between one side of the structural frame and an opposed side of the at least one screen panel, and a grasping element extending out of or into a side of the screen panel opposite the opposed side of the at least one screen panel, wherein manual force can be applied to the grasping element to disengage the fastenable connection system while retaining structure in the fastenable connection system so that a disengaged screen panel can be reattached to the structural frame. The fastenable connection may comprise opposed material interlocking systems.

The grasping element may comprise any mechanical fastener, including those from the non-limiting list of an eye hook, a hook, hook and loop fasteners (e.g., Velcro® fasteners) or a cord. In some constructions, the screen panel may be completely removed and then reattached solely by pressure on the fastenable connection. The at least one screen panel may have multiple grasping elements.

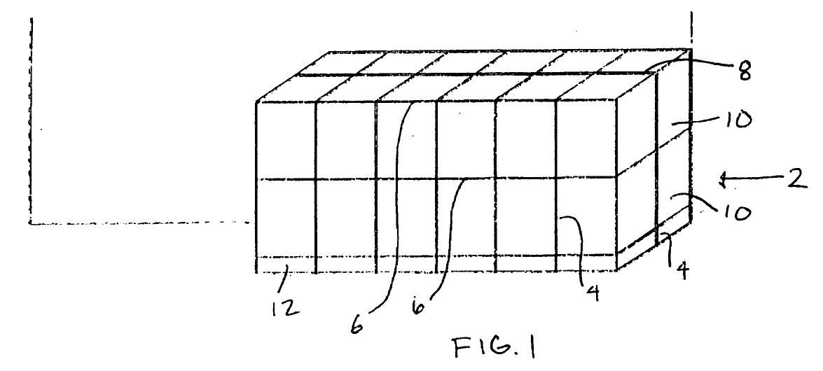

A look at the figures will assist in a better appreciation of the technology described herein. FIG. 1 shows a perspective view of a screen enclosure system 2 for a pool or deck. The system is structurally supported by vertical frames 4, horizontal frames 6 and roof frame 8. There are larger screen sections 10 and possibly smaller screen sections 12 in the system. Note that the structural frames, 68, both horizontal and vertical, can accommodate adjacent panels with edges as in 64, enabled by wider widths of structural members.

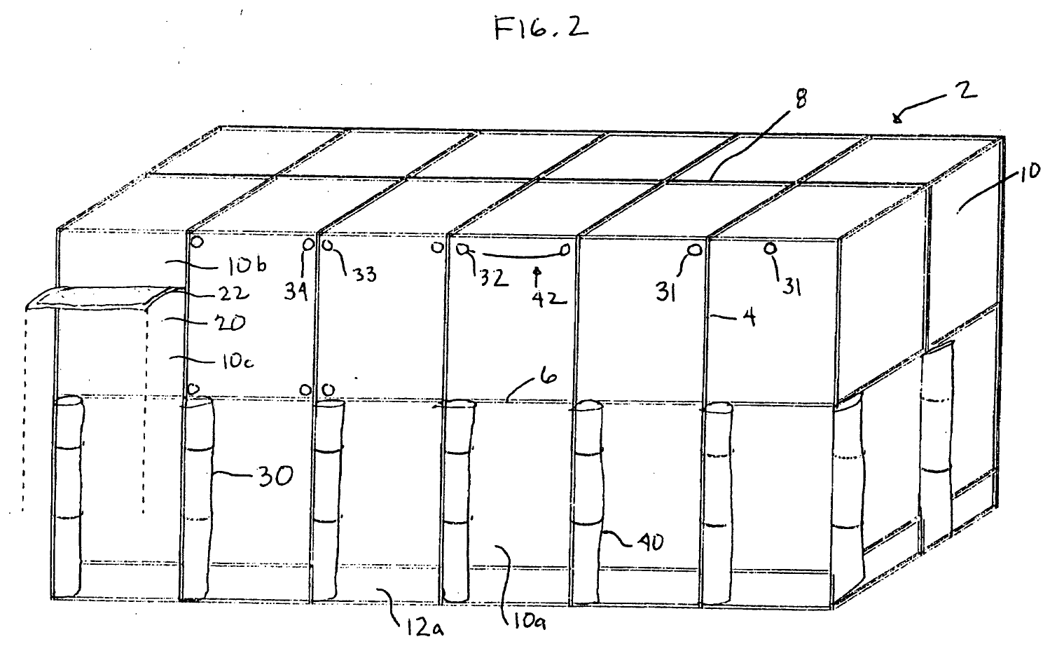

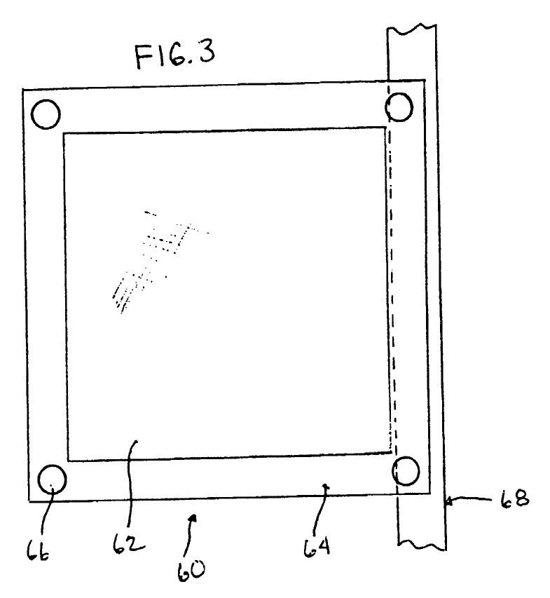

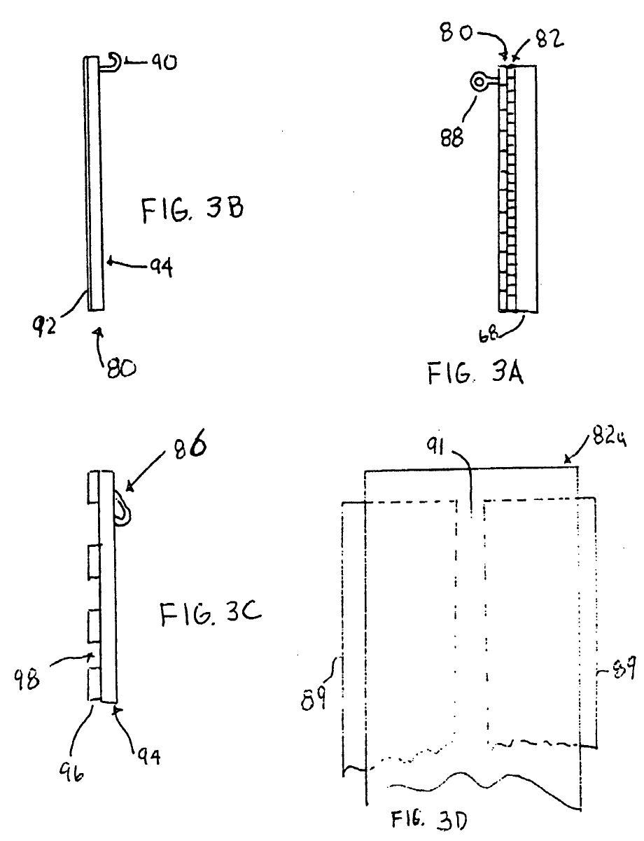

FIG. 2 shows a perspective of a partially disassembled screen enclosure system 2 for a pool or deck. The various frames 4 6 8 are shown, as in FIG. 1. Additionally, FIG. 2 shows a screenless area 10a and a partially screenless area 10b, where the screen segment 20 is being removed. The screen material 10c is shown supported in an edging or framing material 22. A series of engagement or grasping elements 34 33 32 31 are shown on various screen segments. The grasping elements are shown without specific structure, which will be better defined in FIGS. 3A 3B and 3C. It is shown in FIG. 2, however, than a screen segment may have one or more grasping elements, as shown by way of non-limiting examples of four elements 34, three elements 33, two elements 32 or a single element 31 on each segment. The grasping elements may be symmetrical or asymmetrical about the segments. The screen segments may be completely removed from the frames, as indicated in the removal of screen material 20, or removed from three contact points with frames and rolled or stored against a fourth supporting frame, as with rolled screen material 40. The user would manually remove the segments from respective frame elements by engaging whatever number of grasping elements is necessary, or have the additional grasping elements as a redundancy in case of damage to other elements on the screen segment. A fixed element (e.g., string, cord, cable or rod may be attached permanently to the grasping element, or may be kept separate and engaged with the grasping elements 34 33 32 31 as needed. For example, if the grasping element were an eye socket or circular extension, a pole with a hook thereon could be used to engage the circular extension. A cord could also pass between multiple grasping elements (as shown with grasping elements 32 by cord 42) to create a distinct single grasping element, the cord 42 that may itself be pulled by engagement with a hook.

FIG. 3 shows a front view of a panel 60. The panel 60 comprises the screen material 62 with an optional, but desirable framing material 64 that adds some structural integrity and edge protection to the screen material 62. Also shown are four grasping elements 66 and a partially viewed segment of a system structural frame 68. The framing material 64 or the entire panel 60 is removably attached to the structural frame element 68. The screen material may be any screen material that is useful in the environment in which it is placed. General, non-limiting examples include glass, ceramic, metal, composite, polymeric, or other structurally sufficient and environmentally tolerant fibers or mesh. The material is usually woven, but fused warp and weft are also suitable. The framing material may be aluminum, steel, rubber, elastomer, polymer sheeting, fabric or combinations of the materials and its composition is not critical to the practice of the technology. Its primary function is to support the screen, provide a structural area against which force can be applied to assist in removing the screen panel, and to assist in reattaching the screen panel by applying force on the framing material to assist engagement of the securing system during reapplication of the screen panel.

FIGS. 3A, 3B and 3C show alternative grasping assemblies from frames 80.

FIG. 3A shows the screen panel or framing system 80, in which the structural frame 68 from the system has a securing element 82 between the structural frame 68 and the screen frame 80. The securing element may be interlocking or adhering surfaces, especially engaging surfaces such as Velcro® fasteners, especially the heavy duty Velcro® fasteners, Dual Lock™ fasteners (3M Co., St. Paul, Minn.), and Industrial Dual Lock™ fasteners. These systems have opposed surfaces that may tend to be the same (in the Dual Lock™ fastener system) and different (hooks on one side and loops on the other side in the Velcro® fastener systems). Other reusable fastening systems that can be pulled apart with force without immediately destroying the screen and/or the framing material (if any) around the screen. The framing material may itself be one of the sides of the interlocking or engaging securing system. Other securing systems may be plastic snaps or clips, fold-over panel snaps, and other mechanical fasteners having engagement that can be undone by applied force, and be reattached by reapplied force. The framing system 80 attached to the structural frame 68 is shown in FIG. 3A with an eye hook 88 on the framing system 80 which may be engaged by a permanent/semi-permanent cord attached through the eye or by using a pole with a hook on the end to engage the eye hook.

FIG. 3B shows a framing system 80 having an engaging surface 92 on a back side and the framing material and screen 94 on the front side, along with a hook 90 which can be engaged with a string or loop element to apply force to disengage the engaging surface 92 from a structural frame (not shown).

FIG. 3C shows a framing system 80 having a discontinuous engaging surface 96 comprising patches of engaging material (e.g., Dual Lock™ fasteners) on a back side and the framing material and screen 94 on the front side, along with a cord (e.g., nylon) loop 86 which can be engaged with a hook element to apply force to disengage the engaging surface 96 from a structural frame (not shown). The spacing 98 allows for easier disengagement from a support frame (not shown).

FIG. 3D shows a back view of a base support 82a for securing removable screen supports 89. The base support 82a is secured to a frame element (not shown, but e.g., 4 in FIG. 1). The base support 82a may be secured by adhesive or other chemical (e.g., fusion) or other mechanical means (e.g., stapling, bolting, etc.) to the frame elements 4. The base support 82a is usually the element to which the removable screen element is attached, and examples of these are adhesively secured sides of Dual Lock™ securing strips (especially commercial strengths), Velcro® fasteners (again especially commercial strength), and other opposed face securing systems, especially those that can be repeatedly used without destroying the ability of the opposed faces to be repeatedly secured and detached, as with the Dual Lock® system and the Velcro® fastener systems. These system work by mechanical engagement of elements on the surface of each sheet, and the fact that this mechanical engagement can be separated and reengaged by force. In FIG. 3D, it is shown that the support base 82a has two separate screen panel edges 89 attached to a single face of the support base 82a. Thus, a single sheet or layer of the mechanical fastener can be used on a frame surface, and two screen panel edges 89 may be secured against the frame, and each screen panel edge 89 may be separately stripped from the support base 82a, without removing the support base 82a from the frame and without removing the other screen panel edge 89 from the support base. 82a.

The screen removing element that engages gripping or grasping elements 90, or 88, or 86 is not shown as it is merely a rod, stick or pole with a hook or other engaging element (e.g., it may be a loop of “eye” that engages the hook element of FIG. 3B. Screens also may be removed manually by grasping an edge of the screen and lifting or pulling upwards, or to assist in removing screens, which are above normal reach height a rod, stick, or pole may be provided with a hook to engage a loop, grommet, or cord on the screen, or some similar attachment.

In summary, the technology described herein relates to a screen system for providing cover over an area, particularly a pool or patio area that may be subjected to strong winds, such as hurricanes. The screen system embodies a structural frame having height; and at least one screen panel supported on the frame and removably attached to the frame by a fastenable connection system; the fastenable connection system being present between one side of the structural frame and an opposed side of the at least one screen panel. The panels have engaging elements on them, which is a grasping element extending out of or into a side of the screen panel opposite the opposed side of the at least one screen panel. Force can be applied to the grasping element to disengage the fastenable connection system while retaining structure in the fastenable connection system so that a disengaged screen panel can be reattached to the structural frame. The force can be applied by a fixed string, a pole with a corresponding engaging element (hook, eye hook, loop, cord, gripper, latch, locking element, etc.). The screen system may have the fastenable connection comprise opposed material interlocking systems. The screen panel can be completely removed and then reattached solely by pressure on the fastenable connection. At least one screen panel may have multiple grasping elements. The mechanical fasteners may comprise two opposed sheet materials, each sheet of material having small flexible structures on the opposing surfaces of each sheet. The screen system may have mechanical engagement of the fasteners can be separated and reengaged by force. The first sheet of an opposed material interlocking system is secured to the structural frame, and a second sheet of the opposed material interlocking system is secured to a screen panel. The screen system may be structured with the first sheet and the second sheet having identical (Dual Lock® fasteners have this structure) or different (Velcro® fasteners have this structure) interlocking elements on the opposed surfaces.

These features and structures and materials described are intended to be exemplary of generic concepts and are not intended to define limits to the practice of the technology described herein.

What is claimed:

1. A screen system for providing cover comprising:
a structural frame having height;
at least one screen panel;
a fastenable connection system between one side of the structural frame and an opposed side of the at least one screen panel, and a grasping element extending out of or into a side of the screen panel opposite the opposed side of the at least one screen panel, wherein force can be applied to the grasping element to disengage the fastenable connection system while retaining structure in the fastenable connection system so that a disengaged screen panel can be reattached to the structural frame.

2. The screen system of claim 1 wherein the fastenable connection comprises opposed material interlocking systems.

3. The screen system of claim 2 wherein the grasping element comprises an eye hook, a hook or a cord.

4. The screen system of claim 1 wherein the screen panel can be completely removed and then reattached solely by pressure on the fastenable connection.

5. The screen system of claim 1 wherein at least one screen panel has multiple grasping elements.

6. The screen system of claim 4 wherein the mechanical fasteners comprise two opposed sheet materials, each sheet of material having small flexible structures on the opposing surfaces of each sheet.

7. The screen system of claim 6 wherein mechanical engagement of the fasteners can be separated and reengaged by force.

8. The screen system of claim 2 wherein a first sheet of an opposed material interlocking system is secured to the structural frame, and a second sheet of the opposed material interlocking system is secured to a screen panel.

9. The screen system of claim 8 wherein the first sheet and the second sheet have identical interlocking elements on the opposed surfaces.

10. The screen system of claim 8 wherein the first sheet and the second sheet have different interlocking elements on the opposed surfaces.

11. The screen system of claim 10 wherein the different interlocking elements comprise hooks on one opposed surface and loops on another opposed surface.
